(19) United States
(12) Patent Application Publication
(10) Pub. No.: US 2021/0049030 A1
(43) Pub. Date: Feb. 18, 2021

(54) GRAPHICS PROCESSING UNIT PROFILING TOOL VIRTUALIZATION

(71) Applicants: ADVANCED MICRO DEVICES, INC., Santa Clara, CA (US); ATI TECHNOLOGIES ULC, Markham (CA)

(72) Inventors: Louis REGNIERE, Orlando, FL (US); Anthony ASARO, Markham (CA); Jeffrey G. CHENG, Markham (CA)

(21) Appl. No.: 16/542,777

(22) Filed: Aug. 16, 2019

(51) Int. Cl. G06F 9/455

(52) U.S. Cl. CPC G06F 9/45558; G06F 2009/45591

(57) ABSTRACT

The present disclosure relates to techniques for allocating performance counters to virtual functions in response to a request from a respective one of the virtual functions. In response to receiving a request from a respective one of the virtual functions for a performance counter, a security processor is configured to allocate, via a controller, a register associated with a processor to the virtual function, such that the register is configured to implement the performance counter.

### BACKGROUND

In a virtualized computing environment, the underlying computer hardware is isolated from the operating system and application software of one or more virtualized entities. The virtualized entities, referred to as virtual machines, can thereby share the hardware resources while appearing or interacting with users as individual computer systems. For example, a server can concurrently execute multiple virtual machines, whereby each of the multiple virtual machines behaves as an individual computer system but shares resources of the server with the other virtual machines.

In one of the common virtualized computing environments, the host machine is the actual physical machine, and the guest system is the virtual machine. The host system allocates a certain amount of its physical resources to each of the virtual machines so that each virtual machine can use the allocated resources to execute applications, including operating systems (referred to as “guest operating systems”). For example, the host system can include physical devices that are attached to the PCI Express Bus (such as a graphics card, a memory storage device, or a network interface device). When a PCI Express device is virtualized, it includes a “includes a corresponding virtual function for each virtual machine of at least a subset of the virtual machines executing on the device. As such, the virtual functions provide a conduit for sending and receiving data between the physical device and the virtual machines. To this end, virtualized computing environments support efficient use of computer resources, but also require careful management of those resources to ensure secure and proper operation of each of the virtual machines.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a performance counter allocation system configured to allocate performance counters to virtual functions associated with virtual machines executing in a graphics processing unit in accordance with some embodiments.

FIG. 2 is a block diagram illustrating an allocation of performance counters to virtual functions associated with virtual machines executing in a graphics processing unit in accordance with some embodiments.

FIG. 3 is a block diagram illustrating a retrieval of performance data associated with performance counters upon an occurrence of a restore operation of a virtual function during a particular time interval according to some embodiments.

FIG. 4 is a flow diagram illustrating a method for implementing the allocation of performance counters to virtual functions associated with virtual machines in accordance with some embodiments.

### DETAILED DESCRIPTION

Performance counters are used to provide information as to how an aspect of a processing system, such as an operating system or an application, service, or driver is performing. The performance counter data is employed to identify, and remedy specified processing issues, such as system bottlenecks. Applications executing on a processing unit such as a graphics processing unit (GPU) configure registers in the GPU as performance counters that are used to monitor events that occur in the processing unit. The performance counter is incremented in response to the corresponding event occurring. For example, a performance counter that is configured to monitor read operations to a memory is incremented in response to each read of a location in the memory. As another example, a performance counter configured to monitor write operations to the memory is incremented in response to each write to a location in the memory. In some cases, the values of the performance counters are streamed to a memory such as a DRAM that collects and stores state information for subsequent inspection by the software application. For example, values of the performance counters can be written to the memory once per second, ten times per second, at other time intervals, or in response to various events occurring in the processing unit.

However, current virtualization schemes do not provide a mechanism for sharing, allocating, or deallocating registers for use as performance counters for different virtual functions associate with virtual machines. Consequently, virtualization systems are unable to stream performance counter values to memory for subsequent inspection or other uses. The present disclosure discloses techniques for allocating performance counters to virtual machines in response to requests obtained from a virtual function associated with the virtual machine.

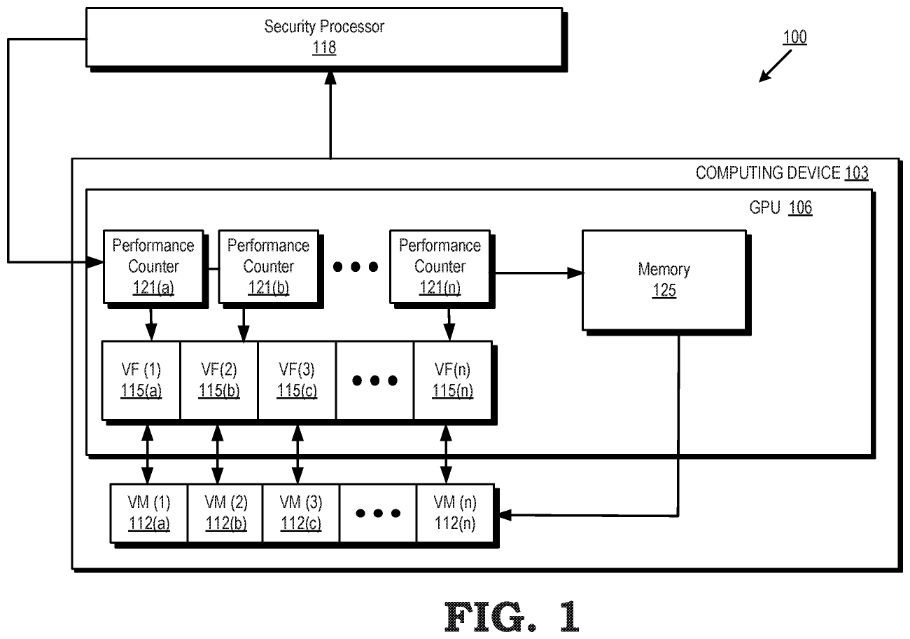

FIG. 1 illustrates a block diagram of a processing system 100 including a computing device 103, wherein the computing device 103 includes a graphics processing unit (GPU) 106. In some embodiments, the computing device 103 is a server computer. Alternatively, in other embodiments the processing system 100 includes a plurality of computing devices 103 that are arranged in one or more server banks or other arrangements. For example, in some embodiments, the processing system 100 is a cloud computing resource, a grid computing resource, or any other distributed computing arrangement including a plurality of computing devices 103. Such computing devices 103 are either located in a single installation or distributed among many different geographical locations. For purposes of convenience, the computing device 103 is referred to herein in the singular. Various applications and/or other functionality is executed by the computing device 103 according to various embodiments.

The graphics processing unit (GPU) 106 is employed by the computing device 103 to create images for output to a display (not shown) according to some embodiments. In some embodiments the GPU 106 is used to provide additional or alternate functionality such as compute functionality where highly parallel computations are performed. The GPU 106 includes an internal (or on-chip) memory that includes a frame buffer and a local data store (LDS) or global data store (GDS), as well as caches, registers, or other buffers utilized by the compute units or any fix function units of the GPU 106.

The computing device 103 supports virtualization that allows multiple virtual machines 112(a)-112(n) to execute at the device 103. Some virtual machines 112(a)-112(n) implement an operating system that allows the virtual machine 112(a)-112(n) to emulate a physical machine. Other virtual machines 112(a)-112(n) are designed to execute code in a platform-independent environment. A hypervisor (not shown) creates and runs the virtual machines 112(a)-112(n) on the computing device 103. The virtual environment implemented on the GPU 106 provides virtual functions 115(a)-115(n) to other virtual components implemented on a physical machine to use the hardware resources of the GPU 106. Each virtual machine 112(a)-112(n) executes as a separate process that uses the hardware resources of the GPU 106. In some embodiments, the GPU 106 associated with the computing device 103 is configured to execute a plurality of virtual machines 112(a)-112(n). In this exemplary embodiment, each of the plurality of virtual machines 112(a)-112(n) is associated with at least one virtual function 115(a)-115(n). In another embodiment, at least one of the virtual machines 112(a)-112(n) is not associated with a corresponding virtual function 115(a)-115(n). In yet another embodiment, at least one of the virtual machines 112(a)-112(n) is associated with multiple virtual functions 115(a)-115(n). In response to receiving a request from a respective one of the virtual functions 115(a)-115(n) for a performance counter 121(a)-121(n).

A single physical function implemented in the GPU 106 is used to support one or more virtual functions 115(a)-115(n). The hypervisor allocates the virtual functions 115(a)-115(n) to one or more virtual machines 112(a)-112(n) to run on the physical GPU on a time-sliced basis. In some embodiments, each of the virtual functions 115(a)-115(n) shares one or more physical resources of the computing device 103 with the physical function and other virtual functions 115(a)-115(n). Software resources associated for data transfer are directly available to a respective one of the virtual functions 115(a)-115(n) during a specific time slice and are isolated from use by the other virtual functions 115(a)-115(n).

The security processor 118 is configured to allocate, via a controller, a register associated with a processor to the virtual function 115(a)-115(n), such that the register is configured to implement the performance counter 121(a)-121(n). In some embodiments, the security processor 118 functions as a dedicated computer on a chip or a microcontroller integrated in the GPU 106 that is configured to carry out security operations. To this end, the security processor 118 is a mechanism to authenticate the platform and software to protect the integrity and privacy of applications during execution.

Performance counters 121(a)-121(n) are a set of special-purpose registers built into the GPU 106 to store the counts of activities or events within computer systems. In some embodiments, performance counters 121(a)-121(n) are used to monitor events that occur in the in the virtual functions 115(a)-115(n) associated with the virtual machines 112(a)-112(n) in the GPU 106.

The memory 125 stores data that is accessible to the computing device 103. The memory 125 may be representative of a plurality of memories 125 as can be appreciated. The memory 125 is configured to store program code, as well as state information associated with each of the virtual functions 115(a)-115(n), performance data associated with each of the performance counters 121(a)-121(n), and/or other data. The data stored in the memory 125, for example, is associated with the operation of various applications and/or functional entities as described below.

Various embodiments of the present disclosure facilitate techniques for allocating registers configured to be implemented as performance counters 121(a)-121(n) to virtual functions 115(a)-115(n) in response to a request from a respective one of the virtual functions 115(a)-115(n) associated with a virtual machine 112(a)-112(n) executing on the GPU 106. For example, in some embodiments, the virtual function 115(a)-115(n) sends a request to the security processor 118 to allocate at least one register configured to implemented as a performance counter 121(a)-121(n) to the requesting virtual function 115(a)-115(n). In response to the request, the security processor 118 determines whether the request obtained from the virtual function 115(a)-115(n) is authorized to access the register or set of register requested by the virtual function 115(a)-115(n). For example, in some embodiments, the security processor 118 determines whether the register or set of registers requested by the virtual function 115(a) is within a permitted set of registers. To this end, in some embodiments, the security processor 118 is configured implement a mask that identifies ranges of registers or individual registers that are available to be configured as performance counters 121(a)-121(n). The mask is applied to filter the requests from the virtual functions 115(a)-115(n) based on the register or registers indicated in the request.

Upon a determination that the request from the virtual function 115(a)-115(n) is unauthorized, the security processor 118 is configured to deny access to the register or set of registers requesting by the virtual function 115(a)-115(n). Alternatively, upon a determination that the request from the virtual function 115(a)-115(n) is authorized to the access the register or set of registers requesting by the virtual function 115(a)-115(n), the security processor 118 allocates the register or set of registers configured to be implemented as performance counters 121(a)-121(n) to the requesting virtual function 115(a)-115(n).

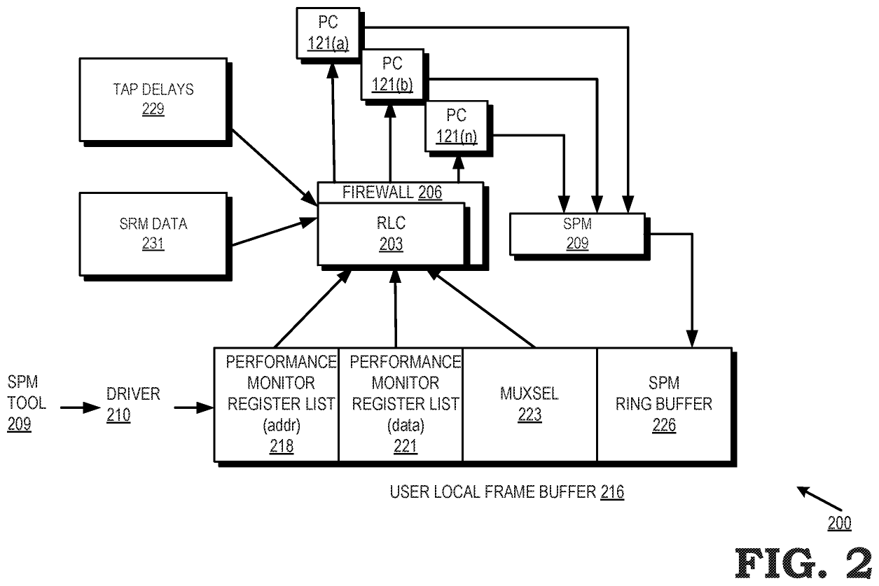

FIG. 2 illustrates an allocation of performance counters 121(a)-121n) to virtual functions 115(a)-115(n) (FIG. 1) associated with virtual machines 112(a)-112(n) (FIG. 1) executing in a graphics processing unit 106 (FIG. 1) in accordance with some embodiments. In some embodiments, a micro processing unit such as a run-list controller (RLC) 203 maintains a list of registers that are available for allocation to virtual functions 115(a)-115(n) (FIG. 1) executing on virtual machines 112(a)-112(n) (FIG. 1) implemented in the processing unit. In some embodiments, the RLC 203 is a trusted computing entity that uses physical addresses to identify locations of the registers.

The firewall 206 is a security hardware mechanism component configured to securely filter communication between computing devices. To this end, the firewall 206 is configured to form a barrier between untrusted computing entities and trusted computing entities. The tap delays 229 and the SPM data 231 are trusted computing entities that are communicated to the RLC 203.

The stream performance monitoring (SPM) tool 209 is configured to utilize the driver 210 to identify the respective one of the virtual functions 115(a)-115(n) currently executing on a virtual machine 112(a)-112(n). The SPM tool 209 is also configured to maintain a list of registers that define memory addresses and other properties for the SPM in the user local frame buffer 216. The list of registers maintained in the user local frame buffer 216 by the SPM tool 209 includes information such as, for example, performance monitor register list (addr) 218 which corresponds to information identifying physical addresses of the registers that are allocated to a virtual function 115(a)-115(n) that is currently executing on a virtual machine 112(a)-112(n), virtual addresses of the registers, performance monitor register list (data) 221, and/or other information. The user local frame buffer 216 also includes information such as, for example, the muxsel 223. The muxsel 223 includes data indicating which performance counters 121(a)-121(n) are associated with the virtual functions 115(a)-115(n), data indicating which events are being monitored by the performance counters 121(a)-121(n), and/or other data. The user local frame buffer 216 also includes a SPM ring buffer 226 which is a data queue where the SPM tool 209 stores the information related to the registers configured to be implemented as performance counters 121(a)-121(n) by the requesting virtual function 115(a)-115(n).

In an exemplary embodiment, the RLC 203 allocates at least one register configured to be implemented as a performance counter 121(a)-121(n) to a virtual function 115(a)-115(n) in response to a request received from the virtual function 115(a)-115(n). The request can include a physical address or a virtual address of the register. For example, the RLC 203 is configured to grant access to any register requested by a virtual function because the RLC 203 is a trusted entity. However, the process of requesting a register to implement a performance counter 121(a)-121(n) for a virtual function 1f5(a)-115(n) and selecting the register at the RLC 203, e.g., by adding the register to the performance counter list maintained by the RLC 203, is a security risk. Therefore, in some embodiments of the present disclosure, the firewall 206 is implemented as a security hardware mechanism by the processing unit to receive the requests from the virtual functions 115(a)-115(n) and forward requests that are within a permitted set of registers to the RLC 203. For example, in one embodiment, the security hardware mechanism is configured to implement a mask that identifies a range of registers or individual registers that are available to be configured as performance counters 121(a)-121(n). The mask is applied to filter the requests from the virtual functions 115(a)-115(n) based on the register or registers indicated in the request.

The virtual functions 115(a)-115(n) are untrusted entities that use virtual addresses to identify the locations of the registers. In some embodiments, a page table that maps the virtual addresses to the physical addresses is populated after a restore operation is performed to restore the performance counter registers based on a stored image of the registers. Therefore, in some embodiments, the RLC 203 and a restored virtual function 115(a)-115(n) are the mapping of the physical addresses used by the RLC 203 to the virtual addresses used by the restored virtual function 115(a)-115(n) differ. In other embodiments, the RLC 203 and the restored virtual functions 115(a)-115(n) are coordinated to ensure that the virtual addresses used to identify the registers associated with the virtual functions 115(a)-115(n) are mapped to the physical addresses used to identify the registers to the RLC 203 prior to construction of the corresponding page table.

In another embodiment, the RLC 203 is also configured to allocate registers to a virtual function 115(a)-115(n) based on state information retrieved in response to the virtual function 115(a)-115(n) being restored to operation on the virtual machine 112(a)-112(n). For example, when a respective one of the virtual machines 112(a)-112(n) is restored on a computing device 103 (FIG. 1) associated with a GPU 106 and a request for a performance counter 121(a)-121(n) is initiated, the RLC 203 is instructed, in response the request, to identify the respective one of the virtual functions 115(a)-115(n) executing during the time interval in which the request occurred, and retrieve the state information associated with the restored virtual function 115(a)-115(n). For example, the state information associated with the restored virtual function 115(a)-115(n) includes a point indicating where a command is stopped prior to completion of the command's execution, a status associated with the restored virtual function 115(a)-115(n), a status associated with the interrupted command, and a point associated with resuming the command (i.e., information critical to restart). In some embodiments, the state information includes location of command buffer in the state of last command being executed, prior to the command's completion, and the metadata location in order to continue once the command is resumed. In some embodiments, this information also includes certain engine states associate with the GPU 106 and the location of other state information.

Once the state information associated with the restored virtual function 115(a)-115(n) is retrieved, the RLC 203 is configured to allocated a set of registers associated with the performance counters 121(a)-121(n) to the restored virtual function 115(a)-115(n) based on the state information associated with the restored virtual function 115(a)-115(n). Instead, the registers associated with performance counters 121(a)-121(n) are restored to a default value (such as zero) in response to a restore operation. Once a virtual function 115(a)-115(n) is restored and is executing on the virtual machine 112(a)-112(n), values of the performance counters 121(a)-121(n) are streamed to memory 125 (FIG. 1), e.g., once every second, once every ten seconds, at other intervals, or in response to other events.

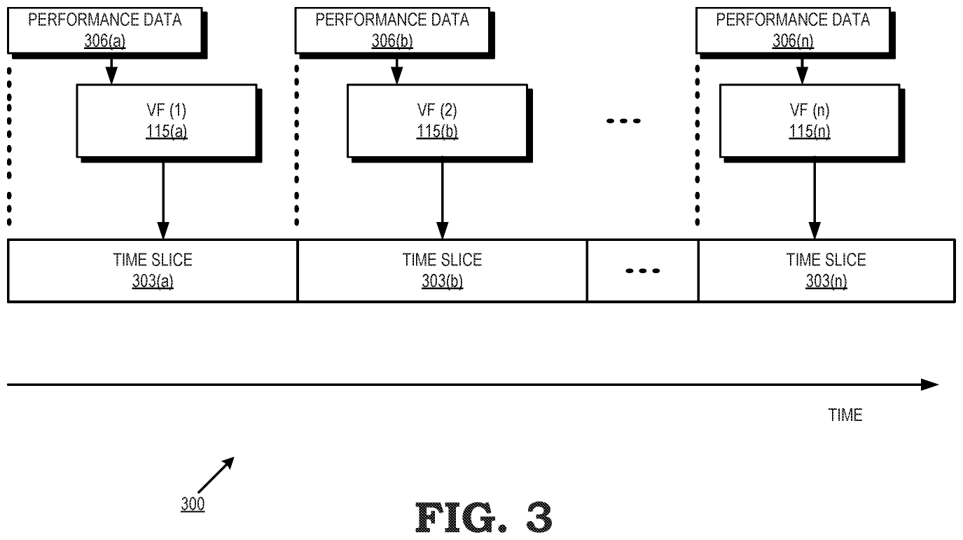

FIG. 3 illustrates a retrieval of performance data 306(a)-306(n) associated with performance counters 121(a)-121(n) (FIG. 1) upon an occurrence of a restore operation of a virtual function 115(a)-115(n) during a particular time interval. Time increases from left to right in FIG. 3. A virtual function 115(a)-115(n) is restored during a first time slice 303(a). Once the first time slice 303(a) is initiated, the performance data 306(a) associated with the respective performance counter 121(a)-121(n) allocated to the virtual function 115(a) is retrieved from memory in response to the restore operation associated with the virtual function 115(a). Similarly, the virtual function 115(b) retrieves the performance data 306(b) associated with the respective performance counter 121(a)-121(n) allocated to the virtual function 115(b) in response to a restore operation associated with the virtual function 115(b). For example, a restore procedure for the virtual function 115(a)-115(n) retrieves an image of the registers that are used to implement performance counters 121(a)-121(n) for the virtual function 115(a)-115(n). The image includes addresses of the registers and information used to configure the performance counter associated with the register, e.g., events that are monitored by the performance counter. Therefore, the image of the performance counter registers therefore do not include values associated with performance counters 121(a)-121(n).

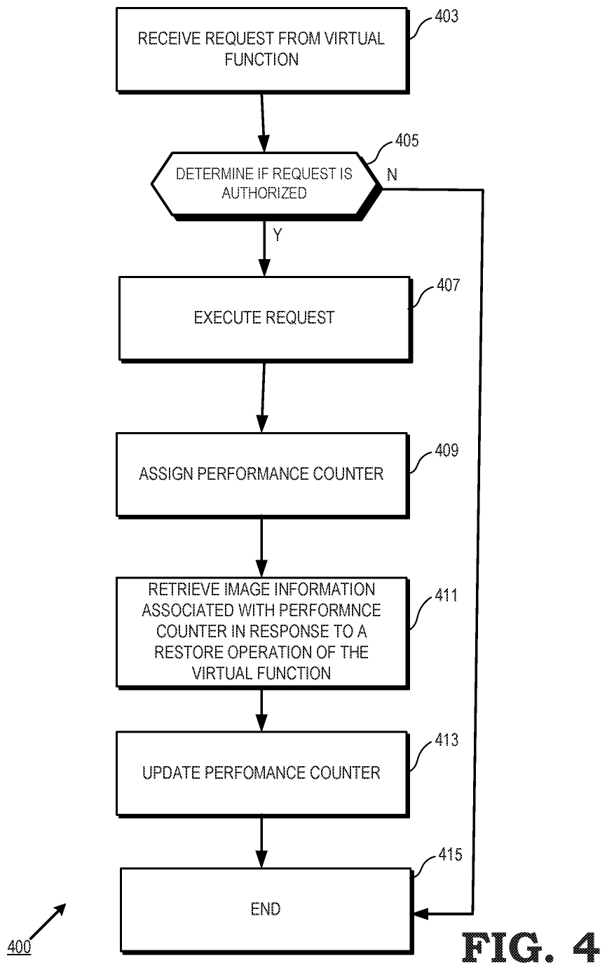

Referring next to FIG. 4, shown is a flowchart that provides one example of a method for implementing the allocation of performance counters to virtual functions associated with virtual machines according to various embodiments. It is understood that the flowchart of FIG. 4 provides merely an example of the many different types of arrangements that are employed to implement the operation of the performance counter allocation system 200 as described herein. As an alternative, the flowchart of FIG. 4 is viewed as depicting an example of steps of a method implemented in a computing device according to various embodiments.

The flowchart of FIG. 4 sets forth an example of the functionality of the performance counter allocation system 200 in facilitating the allocating of registers configured to be implemented as performance counters 12(a)-121(n) associated with corresponding virtual functions 115(a)-115(n) in accordance with some embodiments. While GPUs are discussed, it is understood that this is merely an example of the many different types of devices that are invoked with the use of the performance counter allocation system 200. It is understood that the flow can differ depending on specific circumstances. Also, it is understood that other flows are employed other than those discussed herein

Beginning with block 403, the performance counter allocation system 200 is invoked to perform an allocation of performance counters 121(a)-121(n) to a respective one of the virtual functions 115(a)-115(n) (FIG. 1). The RLC 203 (FGI. 2) is configured to obtain a request for a performance counter 121(a)-121(n) from the virtual function 115(a)-115(n) associated with a corresponding virtual machine 112(a)-112(n). In response the request, the performance counter allocation system 200 moves to block 405. In block 405, the performance counter allocation system 200 determines whether the request for the performance counter 121(a)-121(n) obtained from the virtual function 112(a)-112(n) is authorized. In some embodiments, the firewall 206 (FIG. 2) is configured to allow the request from the virtual function 112(a)-112(n) to be accessed by the RLC 203 when the request is authorized. For example, the firewall 206 is configured determine whether the request from the virtual function 112(a)-112(n) is associated with a set of permitted registers configured to be implemented as performance counters 121(a)-121(n). In other embodiments, the firewall 206 is configured to send an interrupt to the security processor when a request from the virtual function 112(a)-112(n) to access the RLC 203 is denied. Thereafter, the performance counter allocation system 200 ends. Assuming the request obtained from the virtual function 112(a)-112(n) is authorized, the performance counter allocation system 200 moves to block 407. In block 407, the request obtained from the virtual function 112(a)-112(n) is executed by the RLC 203. In some embodiments, upon execution of the request, the RLC 203 is configured to allocate at least one register to a virtual function 115(a)-115(n) in response to a request received from the virtual function 115(a)-115(n). The request can include a physical address or a virtual address of the register.

In another embodiment, the RLC 203 is also configured to allocate registers to a virtual function 115(a)-115(n) based on state information that is retrieved in response to the virtual function 115(a)-115(n) being restored to operation on the virtual machine 112(a)-112(n). For example, when a respective one of the virtual machines 112(a)-112(n) is restored on a computing device 103 (FIG. 1) associated with a GPU 106 and a request for a performance counter 121(a)-121(n) is initiated, the RLC 203 is instructed, in response the request, to identify the respective one of the virtual functions 115(a)-115(n) executing during the time interval in which the request occurred, and retrieve the state information associated with the restored virtual function 115(a)-115(n). The performance counter allocation system 200 then moves to block 409 and assigns performance counters 121(a)-121(n) to the requesting virtual function 112(a)-112(n). The performance counter allocation system 200 then moves to block 411 and retrieves image information associated with the performance counter 121(a)-121(n) in response to the virtual function 115(a)-115(n) being restored to operation. For example, in some embodiments, an image of the registers that are used to implement performance counters 121(a)-121(n) for the virtual function 115(a)-115(n) is retrieved upon restoration of the virtual function 112(a)-112(n) during a time slice 303(a)-303(n). The image includes addresses of the registers and information used to configure the performance counter 121(a)-121(n) associated with the register, e.g., events that are monitored by the performance counter. In some embodiments, the performance counters 121(a)-121(n) are counters that monitor changes in a plurality of monitored events but are not configured to count the total number of monitored events. Therefore, the image of the performance counter registers therefore do not include values associated with performance counters 121(a)-121(n). Instead, the registers associated with performance counters 121(a)-121(n) are restored to a default value (such as zero) in response to a restore operation. Once a virtual function 115(a)-115(n) is restored and is executing on the virtual machine 112(a)-112(n), values of the performance counters 121(a)-121(n) are streamed to memory 125 (FIG. 1), e.g., once every second, once every ten seconds, at other intervals, or in response to other events. After retrieving the image information, the performance counter allocation system 200 moves to block 413 and updates the performance counter based on the retrieved image information.

In some embodiments, the apparatus and techniques described above are implemented in a system including one or more integrated circuit (IC) devices (also referred to as integrated circuit packages or microchips), such as the performance counter allocation system 200 described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving a request from a virtual function associated with a virtual machine for a performance counter;
in response to the request allocating, by a controller, a register associated with a processor to the virtual function, the register being configured to implement the performance counter.

2. The method of claim 1, the controller being configured to implement a hardware security mechanism, the hardware security mechanism being configured to grant the request received from the virtual function, the request being associated with a range of registers available to be configured as performance counters.

3. The method of claim 2, wherein implementing the hardware security mechanism further comprises implementing a mask configured to identify the range of registers.

4. The method of claim 3, the mask being configured to filter the request received from the virtual function based on the register associated with the request.

5. The method of claim 1, the controller being configured to allocate the register based on a set of state information retrieved from the virtual function in response to a restore operation on the virtual machine.

6. The method of claim 5, wherein the register associated with the performance counter is configured to be restored to a default value in response to the restore operation associated with the virtual function.

7. A system comprising:
a processing unit configured to host a plurality of virtual machines, wherein the processing unit comprises a controller configured to allocate at least one register associated with a processor to a virtual function associated with the virtual machine in response to a request from the virtual function, the at least one register being configured to implement at least one performance counter.

8. The system of claim 7, being further configured to store a set of images associated with the at least one performance counter to a memory associated with the processing unit, in response to a detection of an end operation associated with the virtual function.

9. The system of claim 8, being further configured to restore the set of images from the memory to the virtual function in response to a detection of a restore operation associated with the virtual machine.

10. The system of claim 9, wherein the set of images comprises a set of addresses associated with the at least one register and a set of information used to configure the at least one performance counter.

11. The system of claim 10, wherein the set of information comprises a plurality of events configured to be monitored by the at least one performance counter.

12. The system of claim 11, the at least one performance counter being configured monitor changes in each of the plurality of events.

13. The system of claim 7, the controller being configured to allocate the at least one register based on a set of state information retrieved from the virtual function in response to the virtual function being restored to operation on the virtual machine.

14. A system comprising:
a graphic processing unit configured to host a plurality of virtual machines, wherein the graphic processing unit comprises a controller configured to allocate at least one register associated with a processor to a virtual function associated with the virtual machine in response to a request from the virtual function, the at least one register being configured to implement at least one performance counter; and
a security processing unit configured to implement a mask to identify a set of registers, the mask being further configured to filter the request received from the virtual function based at least in part on the request being associated with the set of registers.

15. The system of claim 14, wherein the controller is further configured to allocate the at least one register based on a set of sate information retrieved from the virtual function in response to the virtual function being restored to operation on the virtual machine.

16. The system of claim 14, being further configured to store a set of images associated with the at least one performance counter to a memory associated with the processing unit, in response to a detection of an end operation associated with the virtual function.

17. The system of claim 16, being further configured to restore the set of images from the memory to the virtual function in response to a detection of a restore operation associated with the virtual machine.

18. The system of claim 17, wherein the set of images comprises a set of addresses associated with the at least one register and a set of information used to configure the at least one performance counter.

19. The system of claim 18, wherein the set of information comprises a plurality of events configured to be monitored by the at least on performance counter.

20. The system of claim 19, the at least one performance counter being configured to monitor changes in each of the plurality of events.
